(19) United States
(12) Patent Application Publication
(10) Pub. No.: US 2014/0251168 A1
(43) Pub. Date: Sep. 11, 2014

(54) PRINTING FORM AND A PROCESS FOR PREPARING A PRINTING FORM USING TWO-STEP CURE

(71) Applicant: E I DU PONT DE NEMOURS AND COMPANY, Wilmington, DE (US)

(72) Inventors: Helen S. M. LU, Wallingford, PA (US); Mark E. WAGMAN, Wilmington, DE (US)

(73) Assignee: E I DU PONT DE NEMOURS AND COMPANY, Wilmington, DE (US)

(21) Appl. No.: 14/197,659

(22) Filed: Mar. 5, 2014

Related U.S. Application Data
(60) Provisional application No. 61/773,427, filed on Mar. 6, 2013.

(51) Int. Cl. B41C 1/05; B23K 26/40; B41N 1/22; B41M 1/10; B41N 1/12; B29C 59/00; B05D 3/02

(52) U.S. Cl. CPC B41C 1/05; B29C 59/002; B23K 26/4095; B05D 3/0254; B41M 1/10; B41N 1/12; B41N 1/22
USPC 101/170; 264/447; 264/134; 101/395; 101/375

(57) ABSTRACT

The invention pertains to a printing form and a process for preparing the printing form from a curable composition that includes an epoxy resin, less than a stoichiometric amount of at least one amine curing agent, and optionally a catalytic curing agent and/or a latent curing agent. The process includes applying the curable composition to a supporting substrate to form a layer, partially curing the layer at a first temperature, engraving the partially cured layer, and then completing the curing by heating at a second temperature greater than the first temperature. The less than stoichiometric amount of the amine curing agent guarantees that after the first curing step, epoxy functionalities in the curable composition will be available for second curing step. The optional catalytic curing agent or latent curing agent promotes completion of the cure at higher temperature. The process prepares printing forms, particularly gravure printing forms, having a cured resin composition layer that is engravable, resistant to solvent inks and to mechanical wear, and capable of printing gravure-quality images.

### BACKGROUND OF THE INVENTION

1. Field of the Invention

This invention pertains to a printing form and a process for preparing a printing form, and in particular, a process for preparing a gravure printing form in which one or more conventional metal layers are replaced by one or more epoxy resins that undergo a multistep cure.

2. Description of Related Art

Gravure printing is a method of printing in which the printing form prints from an image area, where the image area is depressed and consists of small recessed cups or wells to contain the ink or printing material, and the non-image area is the surface of the form. A gravure cylinder, for example, is essentially made by electroplating a copper layer onto a base roller, and then engraving the image composed of the small recessed cells or wells digitally by a diamond stylus or laser etching machine. The cylinder with engraved cells is then overplated with a very thin layer of chrome to impart durability during the printing process. Consequently, gravure printing forms are expensive and require considerable time and material to produce.

Replacing the electroplated copper and chrome layers with a polymer-based composition has been explored, for example, by Aoyama et al. (U.S. Pat. No. 4,384,011), Bressler et al. (U.S. Pat. No. 5,694,852), Campbell and Belser (U.S. Patent Publication 2004/0221756), and Kellner and Sahl (UK Patent Application GB 2,071,574). However, a combination of several process and property requirements must be met for gravure printing forms having a polymer-based composition to succeed. For an economical process, a polymer-based coating needs to be applied to the cylinder easily (“coatability”) and cured reasonably rapidly (“curability”), allowing a high-quality surface layer to be produced to the strict tolerances required for gravure engraving and printing with a minimal requirement for grinding and polishing. The surface layer needs to have a level of hardness and toughness that produces well defined print cell structure when engraved, without significant chipping or breaking (“engravability”). The surface layer also needs to possess excellent resistance to the solvents used in gravure printing inks and cleaning solutions (“durability-solvent resistance”). Also, the surface layer needs to resist the mechanical wear (“durability-mechanical wear”) encountered during the printing process. e.g., wear from the scraping of the doctor blade, wear from any abrasive particles that may be in the ink, and wear from the surface onto which the image is printed. Further, in order for gravure printing forms having a polymer-based composition to replace conventional metal-covered gravure printing forms, the polymer-based printing forms should be capable of relatively long print runs and provide a consistent printed image for a minimum of 200,000 impressions.

However, it is difficult to achieve with a layer of a resinous material both good engravability and resistance to wear, scratches, and solvent uptake. A printing surface layer of a resinous material that is suitably engravable is apt to have poor solvent resistance and wear resistance, while excellent wear and solvent resistance are often accompanied by poor engravability.

As a consequence, there remains a need to identify specific compositions and methods that can be used to produce, in an economical and environmentally-friendly manner, a printing form having a surface layer that exhibits the necessary combination of coatability, curability, engravability, solvent resistance, mechanical wear resistance, and print quality.

### SUMMARY OF THE INVENTION

The present invention provides a process for preparing a printing form including a) applying a curable composition comprising i) an epoxy resin having epoxide functionalities, and ii) a less than a stoichiometric amount of at least one amine curing agent, onto a supporting substrate, thereby forming a layer; b) in a first curing step, curing the layer at a first temperature sufficient to cause the at least one amine curing agent to react with the epoxide functionalities of the epoxy resin, wherein the layer after first curing step includes unreacted epoxide functionalities; c) engraving at least one cell in the layer resulting from step b); and d) in a second curing step, further curing the engraved layer at a second temperature greater than the first temperature sufficient to cause the unreacted epoxide functionalities to react, thereby forming the printing form.

In accordance with another aspect of this invention there is provided a process for gravure printing with a printing form including a) preparing the printing form according to the process described above; b) applying an ink to the at least one cell; and c) transferring ink from the cell to a printable substrate, wherein the cured layer swells ≦12% based on weight of the layer.

In accordance with another aspect of this invention there is provided a gravure printing form including a continuous polymer-based print surface adjacent to a supporting substrate, wherein the continuous print surface is a cured epoxy composition prepared by a) applying a curable composition comprising: i) an epoxy resin having epoxide functionalities, and ii) a less than a stoichiometric amount of at least one amine curing agent, onto a supporting substrate, thereby forming a layer; b) in a first curing step, curing the layer at a temperature in a range of room temperature to about a first temperature sufficient to cause the at least one amine curing agent to react with the epoxide functionalities of the epoxy resin, wherein the layer after first curing step includes unreacted epoxide functionalities; c) engraving at least one cell in the layer resulting from step b); and d) in a second curing step, further curing the engraved layer at a second temperature greater than the first temperature sufficient to cause the unreacted epoxide functionalities to react, thereby forming the continuous print surface of the printing form.

### DESCRIPTION OF THE PREFERRED EMBODIMENTS

In the context of this disclosure, a number of terms shall be utilized.

The term “epoxy resin” means uncross-linked monomers or oligomers containing epoxy groups.

The term “epoxy novolac resin” means any of a group of epoxy resins created by the reaction of epichlorohydrin, having the following structure

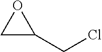

and novolac. The term “novolac” refers to any of the phenol-formaldehyde resins made with an excess of phenol in the reaction, and to any of the cresol-formaldehyde resins made with an excess of cresol in the reaction.

The term “bisphenol-A epoxy resin” means any of a group of glycidyl ether derivatives of bisphenol A,

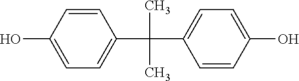 [SMILES: CC(C)(c1ccc(O)cc1)c1ccc(O)cc1]

prepared by reaction of bisphenol A with epichlorohydrin.

The term “bisphenol-F epoxy resin” means any of a group of glycidyl ether derivatives of bisphenol F, prepared by reaction of bisphenol F, i.e., a mixture of p, p′, o, p′, and o, o′ isomers of bis(hydroxyphenyl)methane,

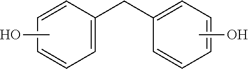

with epichlorohydrin.

The term “epoxy reactive diluent” refers to low viscosity epoxies that are used to modify the viscosity and other properties, such as, wetting and impregnation, of an epoxy composition that is to be cured. Herein, the term “diluent” or “reactive diluent” may be used for brevity in place of “epoxy reactive diluent.”

The term “sub-stoichiometric” or “less than stoichiometric” with respect to an amine curing agent means that the ratio of the curing agent amine hydrogens to the resin epoxy functionalities in the curable composition is less than 1:1, on a mole-to-mole basis. A sub-stoichiometric amount, which may also be referred to as a non-stoichiometric amount, is less than a stoichiometric amount of amine hydrogens of the amine curing agent relative to epoxy functionalities of the epoxy resin, on a mole basis.

The term “stoichiometric” with respect to an amine curing agent means that the ratio of the amine hydrogens of the amine curing agent to the epoxy functionalities of the epoxy resin in the curable composition is 1:1, on a mole-to-mole basis.

The term “solvent” refers to a nonreactive component of a composition that reduces the viscosity of the composition and has a volatility such that it is removed under the conditions (such as temperature) at which the composition is processed.

The term “gravure printing” means a process in which an image is created by engraving or etching one or more depressions in the surface of a printing form, the engraved or etched area is filled with ink, then the printing form transfers the ink image to a substrate, such as paper or another material. An individual engraved or etched depression is referred to as a “cell.”

The term “relief printing” means a process in which a relief surface is created by engraving or etching one or more depressions in the surface of a printing form in which the image area is raised and the non-image area is the depressions, ink is applied to the raised area, and then the printing form transfers the ink image to a substrate, such as paper or another material. An individual engraved or etched depression can be referred to as a “cell.” Letterpress printing is one type of relief printing.

The term “printing form” means an object (e.g., in the form of a cylinder, block, or plate) used to apply ink onto a surface for printing.

The term “room temperature” or, equivalently “ambient temperature,” has its ordinary meaning as known to those skilled in the art and can include temperatures within the range of about 16° C. (60° F.) to about 32° C. (90° F.).

The term “solvent ink” means an ink that includes an organic solvent, typically the organic solvent is volatile, in contrast to water-based inks.

The term “curing” refers to hardening of a polymer material or resin by cross-linking of polymer chains, brought about by chemical additives and heat. Hardening occurs primarily by crosslinking of the polymer chains. Other interactions in the polymer material or resin, such as branching and linear chain extension, can also occur in relatively small degree compared to crosslinking of the polymer chains.

The term “curable composition” as used herein refers to the composition that is applied to a substrate and then cured. The curable composition contains curable polymer material or resin and can include additional components, for example, amine curing agents, anhydrides, diluents, fillers, nanoparticles, flexibilizing components, resin modifiers, pigments, and/or other additives.

The term “catalytic curing agent” as used herein specifically refers to a catalyst that functions as an initiator for epoxy resin homopolymerization. In contrast, a “co-reactive curing agent,” like amine curing agents, promotes curing as a comonomer in the epoxy polymerization process. The term “curing agent” when not modified by “catalytic” or “co-reactive” can be assumed to refer to co-reactive curing agents.

The term “amine curing agent” as used herein refers to an amine curing agent that is capable of curing an epoxy resin at a first temperature.

The term “latent curing agent” as used herein refers to a curing agent that is relatively unreactive at a temperature in a range of room temperature to the first temperature. The latent curing agent reacts substantially under the conditions of the second or final curing step.

The term “accelerator” as used herein refers to a catalyst used in conjunction with a co-reactive curing agent.

The term “amine hydrogen equivalent weight” (AHEW) means the molecular weight of the amine-group-containing molecule divided by the number of amine hydrogens in the molecule. For example, triethylenetetraamine (“TETA”) has a molecular weight of 146 and 6 amine hydrogens, so its AHEW is 146/6=24 g/equiv. If the compound is an adduct of an amine and, e.g., an epoxy, the effective AHEW is based on the amine component.

The term “epoxide equivalent weight” (EEW) means the weight in grams that contains 1 gram equivalent of epoxide.

The term “nanoparticle” means a particle having at least one dimension less than about 500 nm.

The present invention is a process for preparing a printing form from a curable composition, and particularly a process for preparing a gravure printing form from a curable composition. The curable composition comprises i) an epoxy resin, ii) a less than stoichiometric amount of an amine curing agent, and optionally iii) a latent curing agent, and/or iv) a catalytic curing agent. Surprisingly and unexpectedly, the claimed process prepares a polymer-based gravure printing form from the particular curable composition that is capable of meeting several of the property requirements for successful performance comparable to conventional gravure printing forms. Additionally, the claimed process is economical for time and cost such that it can compete with conventional metal-plating processes for gravure printing cylinders. In most embodiments, the form is free of metal layers (other than the support), and in particular is free of copper and chrome layers.

The present process includes forming a layer of a curable composition and multiple steps to cure the layer. Curing the engraveable layer in two curing steps enables the engravability and mechanical wear resistance to be optimized separately, rather than compromising between them. After application to form a layer, the curable composition undergoes a first curing step at a first temperature forming a partially cured layer. The partially cured layer exhibits a level of hardness that is capable of being engraved, and particularly produces well-defined print cell structures when engraved. The partially cured layer of the particular composition can be engraved to have cell density at resolution at least up to 200 lines per inch, with minimal or no break out of wall between adjacent cells. After the layer is engraved, the engraved layer is heated in a second curing step to a second temperature that is greater than the first temperature to complete curing of the resin. The fully cured resin resists wear during printing from contact with the doctor blade and the printed substrate, and abrasive particles that may be in the ink. It is capable of printing for relatively long print runs, i.e., over 100,000 impressions and preferably more, with wear reduction of the cell area of no more than 10%, and in most embodiments wear of less than 5%. Additionally, the cured layer of the particular composition has excellent resistance to solvents used in printing inks and cleaning solutions, such that high quality printing can be maintained for the relatively long print runs. Epoxy resin suitable for use in the present invention can be any such resin or mixture of resins that can be used as a component of a thermally curable composition which in turn can be cured to form an engraveable layer. Epoxy resins and their chemistry are reviewed in “Epoxy Resins,” by Ha. Q. Pham and Maurice J. Marks in Encyclopedia of Polymer Science and Technology, 4th ed., Jacqueline I. Kroschwitz, exec. ed., John Wiley & Sons, Hoboken, N.J., 2004, pp. 678-804. Examples of epoxy resins for the present invention include without limitation: epoxy novolac resins, bisphenol A-based resins, bisphenol F-based resins, epoxidized polyhydroxystyrene resins and mixtures comprising any of these.

Epoxy novolac resin that is created by the reaction of epichlorohydrin and novolac has a phenolic backbone having pendant epoxide groups. The novolac resin can be prepared from unsubstituted phenols and from substituted phenols, such as cresol. Epoxy novolac resins also encompass epoxy cresol novolac resins, wherein the cresol forms the phenolic backbone of the epoxy novolac resin. In most embodiments, the epoxy novolac resins have an average functionality greater than 2.0, which leads to higher cross-linking density upon curing. Epoxy novolac resins with higher crosslinking density have good toughness and chemical resistance, which leads to suitable wear and impact resistance and solvent resistance for use as a printing form.

In some embodiments, the epoxy novolac resins include resins of the following formula (I)

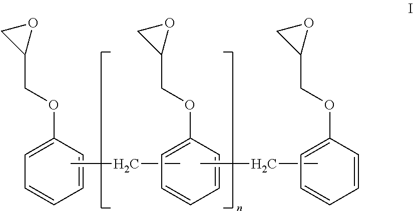

where n can range from about 0.1 to about 5, including fractions therebetween. In some embodiments, n ranges from about 0.2 to about 2.0. Examples of embodiments of the epoxy novolac resins of formula (I) are D.E.N.™ 431, D.E.N.™ 438, and D.E.N.™ 439 (available from The Dow Chemical Company, Midland, Mich., U.S.A.); and EPON™ Resin 160, EPON™ Resin 161 (available from Momentive Specialty Chemicals, Inc., formerly Hexion Specialty Chemicals, part of Momentive Performance Materials Holdings, Inc., Columbus, Ohio, U.S.A).

In some other embodiments the epoxy novolac resins include epoxy cresol novolac resins of the following formula (II)

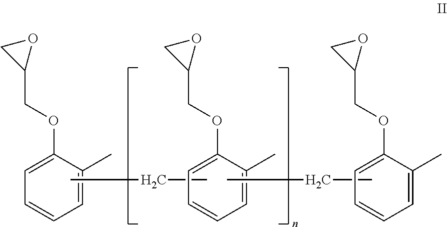

where n can range from about 0.1 to about 4, including fractions therebetween. In some embodiments, n ranges from about 0.2 to about 3. An example of the epoxy novolac resin of formula (II) is Araldite® ECN 9511 (available from Huntsman).

In yet other embodiments the epoxy novolac resins include epoxy novolac resins of the following formula (III)

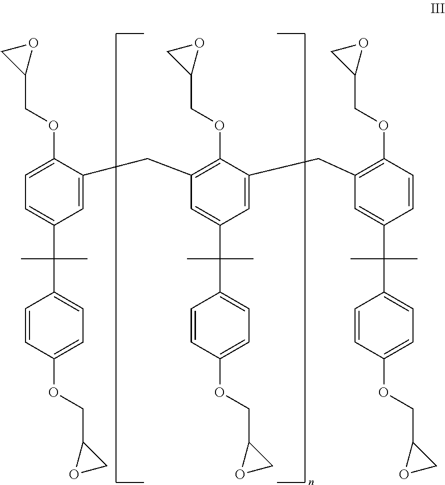

where n can range from about 0 to about 4, including fractions therebetween. In some embodiments, n ranges from about 0 to about 2. An example of an epoxy novolac resin of formula (III) is EPON™ Resin SU-2.5.

Another suitable epoxy resin is bisphenol A diglycidyl ether, “DGEBPA” and its oligomers, represented by formula (IV)

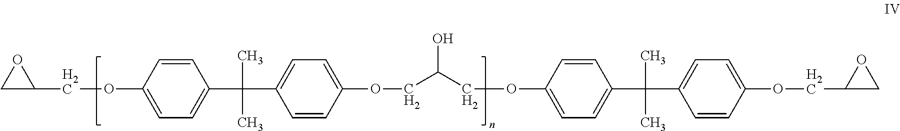

Yet another suitable epoxy resin is bisphenol F diglycidyl ether, “DGEBFA,” and its oligomers, represented by formula (V)

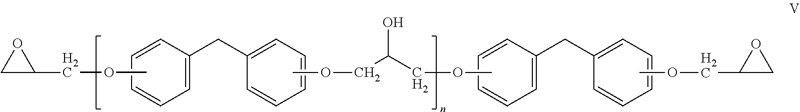

where n can be 0 to about 4. For DGEBPA and DGEBFA, n is 0. Yet another suitable epoxy resin is epoxidized polyhydroxystyrene, represented by formula (VI), which can be synthesized by reacting branched polyhydroxystyrene (“PHS-B”) with epichlorohydrin to form the polyglycidyl ether

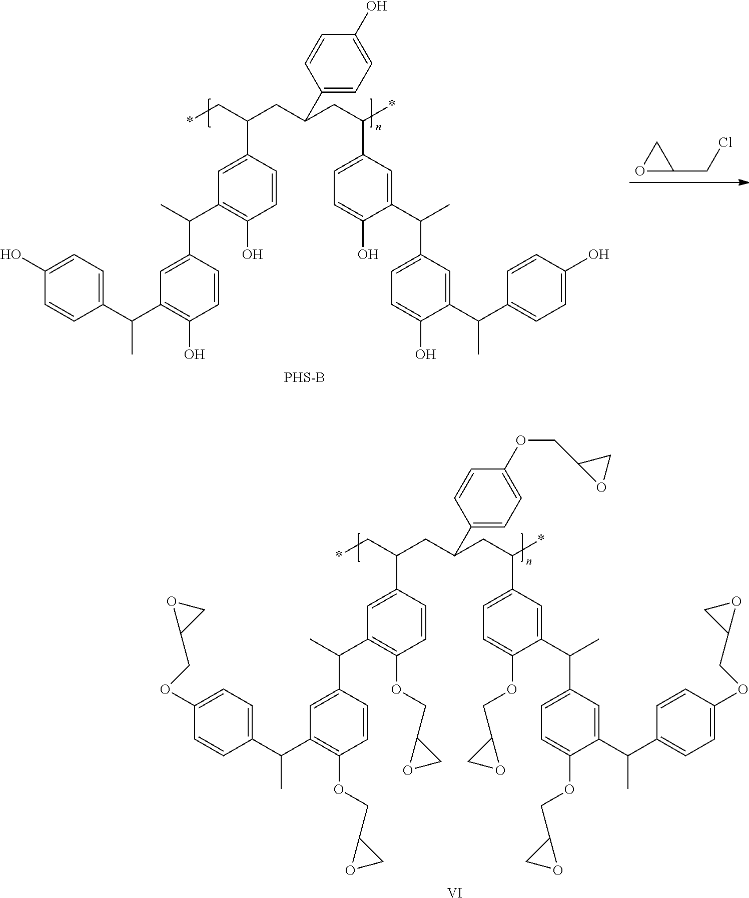

as taught in U.S. Pat. Nos. 6,180,723 and 6,391,979. The number of monomer units n is between about 5 and about 60; in an embodiment, n is between about 10 and about 40.

The epoxy resins of formulas (I) through (VI) each contain a distribution of oligomers, i.e., “-mer” units, and as such, n represents a number of -mer units in the epoxy compounds, per the range of values of n for formula (I) through (VI) recited above. As used herein, the term “-mer” or “-mer units”, encompasses epoxy novolac oligomeric compounds having more than one repeating unit that includes dimers, trimers, tetramers, pentamers, hexamers, and heptamers. In one embodiment, the distribution of -mer units in an epoxy resin includes a mixture of several or all possible (i.e., dimers through heptamers), such that n represents an average number of -mer units in the resin. In other embodiments, the distribution of -mer units in an epoxy resin includes a mixture of several or all possible (i.e., dimers through heptamers), such that n represents the predominant species of oligomers in the mixture. As an example, the epoxy to novolac of formula (I) wherein n equals 2.4, is a mixture of oligomers (i.e., a mixture of dimers, trimers, tetramers, pentamers, and hexamers, and perhaps heptamers), where the predominant species is tetramers and pentamers. For the epoxy novolac resins represented by formulas (I), (II), and (III), n can be between and optionally include any two of the following values: 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, per the range for n that is recited above. For the bisphenol A and bisphenol F resins represented by formulas (IV) and (V) respectively, n can be between and optionally include any two of the following values: 0, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, and 16.5. For the epoxidized polyhydroxystyrene resins represented by Formula VI, n, the number of monomer units, can be between and optionally include any two of the following values: 5, 10, 15, 20, 25, 30, 35, 40, 45, 50, 55, and 60.

Amine curing agents used in the processes described herein include primary aliphatic amines, primary cycloaliphatic amines, secondary aliphatic amines, and secondary cycloaliphatic amines. The curable composition includes at least one amine curing agent, and can include more than one amine curing agents or a mixture of amine curing agents. In most embodiments, the at least one amine curing agent is multifunctional, that is, the amine curing agent contains two or more amine hydrogens that can react with epoxide group of the epoxy resin. Amine curing agents are able to crosslink the epoxy resin at a first temperature. Amine curing agents are primarily suitable for the present process because they increase the cure speed of the curable composition compared to other possible curing agents such as acids and/or anhydrides, and are capable of curing the composition at moderate temperatures. The first curing step occurs at moderate temperatures and so in most embodiments, the first temperature is in a range of room temperature to about 150° C. The first temperature in some embodiments is in a range from room temperature to about 130° C., and in other embodiments is in a range from room temperature to about 120° C. The amine curing agent is present in an amount less than a stoichiometric amount relative to the epoxy resin in the curable composition, on a mole basis. That is, a ratio of the amine hydrogens of the at least one amine curing agent to the epoxy functionalities (i.e., epoxide groups) of the epoxy resin is less than 1 to 1. In one embodiment, the amine curing agent is present in the amount wherein the ratio of the amine hydrogens of the amine curing agent to the epoxy functionalities of the epoxy resin is about 0.30:1.0 to about 0.90:1.0. In another embodiment, the amine curing agent is present in the amount wherein the ratio of the amine hydrogens of the amine curing agent to the epoxy functionalities of the epoxy resin is about 0.30:1.0 to about 0.75:1.0. The at least one amine curing agent completely or substantially completely reacts with epoxy functionalities, i.e., epoxide groups, under the conditions, i.e., at the first temperature for a sufficient time period, of the first curing step. However, the curing conditions of the first curing step are insufficient or substantially insufficient for remaining epoxy groups or epoxy functionalities to react with each other and further polymerize. And since the epoxy functionalities are in greater amount than the amine hydrogens of the at least one amine curing agent, an excess of epoxy functionalities will remain after the first curing step, and are available for the second curing step. The amine curing agent can also be provided in the form of an adduct of an amine curing agent with one or more of the epoxy resins or reactive diluents of the instant invention. The amine curing agent reacts with the epoxy resin as a comonomer, i.e., as a “co-reactive” curing agent.

In most embodiments, amine curing agents are characterized by an amine hydrogen equivalent weight (AHEW) less than or equal to about 150 g/equivalent. In some embodiments, the amine hydrogen equivalent weight can be between and optionally include any two of the following values: 5, 10, 20, 30, 40, 50, 60, 70, 80, 90, 100, 110, 120, 130, 140, and 150 g/equivalent. Having amine hydrogen equivalent weight of less than or equal to about 150 g/equivalent aids in providing a final cured layer of the composition with a sufficient degree of solvent resistance such that print quality can be maintained for print run lengths of at least 100,000 impressions or more. Solvent resistance of the resin-based layer on the printing form is particularly important since many inks used in gravure printing are solvent-based inks, and attack by solvents of the resin-based layer can cause the layer to swell and thereby detrimentally impact print quality and run length.

The curable composition optionally comprises a “latent curing agent.” The term “latent curing agent” as used herein refers to a curing agent that is relatively unreactive at the range of temperature from room temperature to the first temperature. The latent curing agent reacts substantially under the conditions of the second curing step. The latent curing agents include, but are not limited to, aromatic amines (e.g., m-phenylenediamine, or diaminodiphenylsulfone), blocked amines (e.g. Aradur® 9506 from Huntsman), dicyandiamide, anhydrides (e.g. methyltetrahydrophthalic anhydride, nadic methyl anhydride, methylhexahydrophthalic anhydride). The latency of these curing agents arises from either the intrinsic slower reactivity (in the cases of aromatic amines and anhydrides) and/or the lack of solubility of the cure agent in the epoxy matrix (in the cases of Aradur® 9506 and dicyandiamide). In general, the amount of latent curing agent when present will be complementary to the ratio of the amine curing agent curative functionalities to the epoxy functionalities. In embodiments where one or more latent curing agents are included with the curable composition, the latent curing agent is present prior to curing, at about 0.25:1.0 to about 0.70:1.0 of the latent curing agent curative functionalities to the resin epoxy functionalities.

The epoxy resin can be cured in the first curing step in the presence of the at least one amine curing agent and, optionally, an “accelerator,” which, as used herein, means a catalyst used in conjunction with a co-reactive curing agent. Epoxy curing reactions are described in “Epoxy Resins” by Ha. Q. Pham and M. J. Marks, op. cit. Suitable accelerators include, but are not limited to, tertiary amines and phenols, such as: dimethylaminomethyl phenol [25338-55-0], 2,4,6-tris(dimethylaminomethyl)phenol [90-72-2], dimethylaminoethanol (DMAE), benzyldimethylamine (BDMA), 1,8-diazabicyclo[5.4.0]undec-7-ene (DBU), phenol, resorcinol, poly(4-vinyl phenol) and nonyl phenol.

The curable composition optionally includes a “catalytic curing agent” which catalyzes epoxy homopolymerization at a second temperature of the second curing step. The second temperature is greater than the first temperature of the first cure step. Since the at least one amine curing agent is essentially consumed in the first curing step, remaining epoxy functionalities of the epoxy resin react at the conditions for the second curing step. The catalytic curing agent is active at the higher temperature of the second curing step. There are two main types of catalytic curing agents, anionic (Lewis bases) and cationic (Lewis acids). Examples of suitable catalytic curing agents that are Lewis bases include, without limitation, 2-methylimidazole [693-98-1], 2-ethyl-4-methylimidazole [931-36-2], and 2-phenylimidazole [670-96-2], and ureas. The tertiary amines identified above as accelerators can also serve as catalytic curing agents, though they are most commonly used as accelerators with aliphatic amine curing agents, but can also accelerate reaction of epoxy with epoxy, with aromatic amines, with polyamides, with anhydrides, and with phenols. Examples of suitable catalytic curing agents that are Lewis acids include, without limitation, boron trifluoride-monomethylamine, boron trifluoride-monoethylamine, boron trifluoride-dimethyl ether, boron trifluoride-diethyl ether, and boron trifluoride-tetrahydrofuran, boron trichloride-trimethylamine [1516-55-8].

Optionally, one or more diluents can be used to achieve desired viscosity of the curable composition while maintaining desired properties of the cured composition. The epoxy reactive diluents are low viscosity epoxies that are used to modify the viscosity and other properties, such as, wetting and impregnation, of the epoxy composition that is to be cured. The viscosity of the epoxy reactive diluents is typically less than about 300 cp at room temperature. Examples of monofunctional diluents include without limitation: p-tertiarybutyl phenyl glycidyl ether, cresyl glycidyl ether, 2-ethylhexyl glycidyl ether, C₈-C₁₄ glycidyl ether. Examples of difunctional diluents include, without limitation, 1,4-butanediol diglycidyl ether; neopentyl glycol diglycidyl ether; and cyclohexane dimethanol diglycidyl ether. An example of a trifunctional diluent is trimethylol propane triglycidyl ether. When used, the diluent or mixture of diluents is used in large enough amounts that the curable composition is coatable on a cylinder, having a viscosity in the range of about 200 to about 3500 cp at the coating temperature in one embodiment, and a viscosity of about 200 to about 5000 cP at the coating temperature in another embodiment; and yet in small enough amounts that the chemical resistance and other properties of the completely cured composition are not impaired.

Optionally, the curable composition can include up to about 30 parts by weight nanoparticles, i.e., particles having at least one dimension less than about 500 nm. In an embodiment, the value of the at least one dimension is between and optionally including any two of the following values: 1, 10, 50, 75, 100, 200, 300, 400, and 500 nm. In an embodiment, the value is between about 1 and about 100 nm. The nanoparticles can be present in an amount between and optionally including any two of the following values: 0, 0.1, 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30 parts by weight based on the combined weight of the components in the curable composition, and nanoparticles. The nanoparticles can provide hardness and modulus of the composition, which can lead to increased wear resistance and improved engravability of a cured layer of the composition. In one embodiment, the nanoparticles are present in an amount between about 0.1 and about 25 parts by weight; in some embodiments, the nanoparticles are present between about 0.1 to about 15 parts by weight; and in some other embodiments, are present in an amount between about 10 to 20 parts by weight, based on the combined weight of the components in the curable composition.

Optionally, the nanoparticles can be coated or subjected to a surface treatment with, for example, an organic onium species, to improve interaction between the nanoparticles and the resin.

Examples of suitable nanoparticles include, but are not limited to: aluminum oxides (e.g., alumina); silica (e.g., colloidal silica and fumed silica); zinc oxide; zirconium oxide; titanium oxide; magnesium oxides; tungsten oxides; tungsten carbides; silicon carbide; titanium carbide; boron nitrides; molybdenum disulfide; clays, e.g., laponite, bentonite, montmorillonite, hectorite, kaolinite, dickite, nacrite, halloysite, saponite, nontronite, beidellite, volhonskoite, sauconite, magadite, medmonite, kenyaite, vermiculite, serpentines, attapulgite, kulkeite, alletite, sepiolite, allophane, imogolite; carbon nanotubes; carbon black; carbon filaments; and mixtures thereof.

Optionally, the curable composition can include fillers as a solid lubricant to impart improved wear characteristics of the cured composition layer. Fillers include particles having at least one dimension greater than about 500 nm, and generally between about 500 nm to about 5 micron. Examples of fillers, include but are not limited to, tungsten carbides; silicon carbide; titanium carbide; boron nitrides; molybdenum disulfide; graphites; poly(tetrafluoroethylene); and mixtures thereof.

Optionally, the curable composition can include resin modifiers. Resin modifiers can be used to increase crosslinking density and/or stabilize the crosslinked network, which can provide improved end-use characteristics, such as increased solvent resistance, wear resistance, and/or improve engravability of the cured layer of the composition. Resin modifiers include, but are not limited to, acrylate monoesters of alcohols and polyols; acrylate polyesters of alcohols and polyols; methacrylate monoesters of alcohols and polyols; and methacrylate polyesters of alcohols and polyols; where the alcohols and the polyols suitable include alkanols, alkylene glycols, trimethylol propane, ethoxylated trimethylol propane, pentaerythritol, and polyacrylol oligomers. A combination of monofunctional and multifunctional acrylates or methacrylates can be used. The curable composition can include resin modifiers at up to about parts by weight, based on the combined weight of all the components in the composition.

The curable composition optionally can include additives to the epoxy resin, such as flexibilizing components, non-reactive (and non-volatile at curing conditions) diluents (such as, dibutyl phthalate), surfactants, dispersants, dyes, pigments, and wetting and leveling additives for coating uniformity and appearance. Epoxy can be flexibilized as described in, e.g., Epoxy Resins Chemistry and Technology, Clayton A. May editor, 2^{nd} edition, Marcel Dekker, Inc., NY. Suitable flexibilizing components include, but are not limited to, polyamides, carboxylated polymers, fatty diamines, polyglycol diepoxides, and polyurethane amines (including polyetherurethane amines). In some embodiments, polyurethane amine or polyetherurethane amine (e.g., Aradur® 70BD, available from Huntsman International LLC, Salt Lake City, Utah, U.S.A.) can be included in the curable composition as a flexibilizing component.

The curable composition includes at least the epoxy resin, and the at least one amine curing agent, as described above. In some embodiments, the curable composition can include or can consist essentially of the epoxy resin, the at least one amine curing agent, and the catalytic curing agent.

In some embodiments, the curable composition can include or can consist essentially of the epoxy resin, the at least one amine curing agent, and the latent curing agent.

In some embodiments, the curable composition can include or can consist essentially of the epoxy resin, the at least one amine curing agent, the catalytic curing agent, and the latent curing agent.

In some other embodiments, the curable composition can include or can consist essentially of the epoxy resin, the at least one amine curing agent, the accelerator, the catalytic curing agent and/or the latent curing agent.

In some other embodiments, the curable composition can include or can consist essentially of the epoxy resin, the at least one amine curing agent, the catalytic curing agent, and a diluent or mixture of diluents.

In some other embodiments, the curable composition can include or can consist essentially of the epoxy resin, the at least one amine curing agent, and the catalytic curing agent, and nanoparticles.

In yet other embodiments, the curable composition can include or can consist essentially of the epoxy resin, the amine curing agent, the catalytic curing agent, and a diluent or mixture of diluents, and nanoparticles.

In some embodiments, the curable compositions include the epoxy resin at about 40 to 90 parts by weight, the amine curing agent at about 4 to 25 parts by weight, the catalytic curing agent at about 0 to 10 parts by weight, the latent curing agent at about 0 to about 25 parts by weight, the diluent or mixture of diluents at about 0 to about 40 parts by weight, and the nanoparticles at about 0 to about 30 parts by weight. In some embodiments, the epoxy resin is present in an amount between and optionally including any two of the following values: 40, 45, 50, 55, 60, 65, 70, 75, 80, 85, and 90 parts by weight. In some embodiments, the amine curing agent is present in an amount between and optionally including any two of the following values: 4, 7, 10, 12, 15, 17, 20, 22, and 25 parts by weight. In some embodiments, the catalytic curing agent is present in an amount between and optionally including any two of the following values: 0, 1, 2, 3, 4, 5, 6, 7, 8, 9, and 10 parts by weight. In some embodiments, the latent curing agent is present in an amount between and optionally including any two of the following values: 0, 1, 5, 10, 12, 15, 17, 20, 22, and 25 parts by weight.

In some embodiments, the diluent or mixture of diluents is present in an amount between and optionally including any two of the following values: 0, 5, 10, 15, 20, 25, 30, 35, and 40 parts by weight. In some embodiments, the nanoparticles can be present in an amount between and optionally including any two of the following values: 0, 4, 7, 10, 12, 15, 17, 20, 22, 25, 27, and 30 parts by weight.

In one embodiment, the curable composition used for the printing form can include or can consist essentially of a) the epoxy resin selected from epoxy novolac resins, bisphenol-based resins, epoxidized polyhydroxystyrene resins or combinations thereof; b) one or more amine curing agents selected from primary aliphatic amines, primary cycloaliphatic amines, secondary aliphatic amines, secondary cycloaliphatic amines, or combinations thereof; and optionally, one or more epoxy reactive diluents and/or solvents.

In another embodiment, the curable composition used for the printing form can include or can consist essentially of a) the epoxy resin selected from epoxy novolac resins, bisphenol A-based resins, bisphenol F-based resins, epoxidized polyhydroxystyrene resins or combinations thereof; b) one or more amine curing agents selected from primary aliphatic amines, primary cycloaliphatic amines, secondary aliphatic amines, secondary cycloaliphatic amines, or combinations thereof; and, c) a catalytic curing agent selected from Lewis bases, Lewis acids, tertiary amines, or combinations thereof; and/or d) latent curing agents selected from aromatic amines, blocked amines, dicyandiamides, anhydrides, and combinations thereof; and optionally, one or more epoxy reactive diluents and/or solvents.

In one other embodiment, the curable composition used for the printing form can include or can consist essentially of a) the epoxy resin selected from epoxy novolac resins, bisphenol A-based resins, bisphenol F-based resins, or combinations thereof; b) one or more amine curing agents selected from ethyleneamines; and c) a catalytic curing agent selected from imidazoles; and/or d) latent curing agents selected from aromatic amines, dicyandiamides, blocked amines, anhydrides, and combinations thereof.

In an embodiment, the curable composition as described above further includes up to about 30 parts by weight nanoparticles; in another embodiment, up to 20 parts by weight nanoparticles, such as alumina nanoparticles or silica nanoparticles.

### Process

The process for preparing a printing form includes applying the curable composition as described above; curing the layer in a first curing step at a first temperature; engraving at least one cell in the layer resulting from the first curing step; and curing the engraved layer in a second curing step at a second temperature greater than the first temperature. In most embodiments, the process includes the following steps in order a) applying the curable composition as described above; b) curing the layer in a first curing step at a first temperature; c) engraving at least one cell in the layer resulting from the first curing step; and d) curing the engraved layer in a second curing step at a second temperature greater than the first temperature.

The process of preparing a printing form includes applying the curable composition onto a supporting substrate, to form a layer of the curable composition. The composition can be applied to the supporting substrate by various means that are well known in the art. The method of the present invention is particularly applicable to the application of the curable composition as a liquid to a supporting substrate that can be used as a printing roll or print cylinder in a rotogravure printing process. The supporting substrate can also include a planar support sheet that is typically composed of a metal. The supporting substrate, e.g., printing roll or print cylinder, can be made of metal (e.g., aluminum or steel) or a polymeric material. Prior to the application of the curable composition to the supporting substrate, an exterior surface of the supporting substrate that receives the composition can be pretreated by means of a plasma or corona pretreatment to clean and/or alter the surface (i.e., lower the surface tension) of the supporting substrate for improved film or coating wetout and bonding strengths. Additionally or alternatively, a primer solution, such as an epoxy primer solution, can be applied to the exterior surface of the supporting substrate to improve adhesion of the curable (and cured) composition to the supporting substrate.

The curable composition can be applied to the supporting substrate by any suitable method, including but not limited to, injection, pouring, liquid casting, jetting, immersion, and coating. Examples of suitable methods of coating include spin coating, dip coating, slot coating, roller coating, extrusion coating, brush coating, ring coating, and blade (e.g., doctor blade) coating, all as known in the art and described in, e.g., British Patent No. 1,544,748. Application of the curable composition in powdered form on the supporting substrate is excluded. The process to apply the curable composition as a powdered coating involves fusing the solids together and cure at very high temperatures, typically greater than 200° C. Disadvantages associated with the application of powder curable compositions include the cost of coating equipment and environmental controls, the need for low relative humidity conditions for a quality coating, and difficulty in achieving void-free coatings. It is preferred that the curable composition is applied as a liquid to avoid the disadvantages of powder application. In most embodiments, the curable composition is applied as a liquid having a viscosity of about 200 to about 3500 cP onto the surface of the supporting substrate, such as the printing roll or cylinder. In one embodiment, the curable composition is applied to the exterior surface of the supporting substrate by brush coating in a manner similar to that described in U.S. Pat. No. 4,007,680. In most embodiments, the curable composition is applied so as to form a continuous or seamless layer on a cylindrically-shaped supporting substrate, so as to provide a continuous print surface for the printing form (after curing and engraving). In some embodiments, application of the curable composition occurs at room temperature. In other embodiments, application of the curable composition occurs at a temperature above room temperature. The curable composition, as applied to the surface of the supporting substrate, forms a layer that has a thickness between about 2 to about 300 mils (50.8 to 7620 μm). Optionally the thickness of the curable composition layer can be in a range between and optionally including any two of the following thicknesses: 2, 4, 8, 12, 16, 20, 50, 100, 150, 200, 250, and 300 mils (50.8, 102, 203, 305, 406, 508, 1270, 2540, 3810, 5080, 6350, and 7620 μm).

The process of preparing a printing form includes curing the layer at the first temperature. After the curable composition is applied to the supporting substrate, the layer of the composition is cured at the conditions of the first curing step to sufficiently harden on the supporting substrate, so that the layer is capable of being engraved. Hardening of the resin composition occurs by crosslinking of polymer chains of the epoxy resin brought about by the reactive components in the composition, such as the at least one amine curing agent, the optional accelerator, and the optional reactive diluent, with reactive groups in the resin. The use of a less than stoichiometric amount of the at least one amine curing agent and heating to a first temperature ensures that the reaction of the amine hydrogens with epoxy functional groups, i.e., epoxide groups, of the epoxy resin occurs, and thus the layer will be sufficiently cured for engraving. Since unreacted epoxide groups will remain after the amine curing agent is consumed or substantially consumed by the first curing step, the layer may be considered to be only partially cured. In most embodiments, the first temperature is in the range of room temperature to about 150° C., and the curable compositions described herein are partially cured thermally (i.e., by heating) in less than about 6 hours. In some embodiments, the layer of the curable compositions are partially cured thermally in less than 4 hours; in some other embodiments, the curable compositions are partially cured thermally in about 1 hour to about 2 hours. It should be noted that crosslinking can begin during heating to the first temperature of the first curing step, but that the reaction goes to completion or substantial completion when heated at the first temperature for a suitable time that is reasonable for a commercially viable process. In general, the rate of curing for the first curing step will be rather slow in the low end of the temperature range. So it is desirable for commercially viable systems to conduct the first curing step at higher temperature/s at which the rate of curing (of the amine hydrogen and epoxide functionality) is significant, but not so high a temperature as to induce reaction of the unreacted epoxide groups (e.g., by polymerization reaction/s and/or reaction of the latent curing agent with the epoxy) that are to occur during the second curing step. The conditions for the first curing step, which includes times and temperatures, will depend on the specific curable composition and the type and amount of amine curing agent and are readily determined by one skilled in the art. More specifically, the temperature for the first curing step is in a range between and optionally including any two of the following values: 16, 30, 40, 50, 60, 70, 80, 90, 100, 110, 120, 130, 140, and 150° C.

The hardened layer of the curable composition (after application to the surface of the supporting substrate and partial curing) has a thickness that is from about 2 to about 300 mils (50.8 to 7620 μm). The thickness of the partially cured layer is in a range between and optionally including any two of the following thicknesses: 2, 4, 8, 12, 16, 20, 50, 100, 150, 200, 250, and 300 mils (50.8, 102, 203, 305, 406, 508, 1270, 2540, 3810, 5080, 6350, and 7620 μm). Optionally, the partially cured layer can be ground and polished to desired thickness, cylindricity, and/or smoothness, prior to engraving as disclosed in U.S. Pat. No. 5,694,852. The smoothness of the partially cured layer can be reported as Rz value. In most embodiments, the smoothness of the cured layer has Rz value less than about 100 microinches; and, in other embodiments, the Rz value is less than about 80 microinches.

The process of preparing a printing form includes engraving at least one cell into the partially cured layer of the composition on the supporting substrate. Engraving of the partially cured composition layer removes the hardened composition in depth to form a plurality of individual cells in the layer, yet still is a continuous layer of the composition. Engraving provides the partially cured layer with characteristics necessary to print desired images, graphics and text content onto a printable substrate, i.e., engraving provides the layer with printing characteristics. For gravure printing, the plurality of individual cells in the layer are for carrying ink which transfers, in whole or part, during printing of the desired image. For relief printing, the surfaces raised above the plurality of individual cells in the layer carry the ink which transfers, in whole or part, during printing of the desired image. The engraving of the plurality of cells in the partially cured layer on the supporting substrate provides a printing form or, equivalently, an image carrier, having a printing surface that is capable of reproducing the desired image by printing onto a substrate. The engraving can be accomplished by any of various engraving methods known in the art. Examples include, but are not limited to, electromechanical engraving (e.g., with a diamond stylus) and laser engraving. These engraving methods can be part of an electronic engraving system. In one embodiment, engraving is carried out using a diamond stylus cutting tool. In another embodiment, direct laser non-contact engraving is used for the creation of the ink cells. The laser can be CO₂, YAG, or Diode type laser. The present process of preparing the printing form having a partially cured layer of the epoxy composition is advantageous in that the partially cured layer can be engraved using conventional engraving equipment at standard or substantially standard conditions that are used to engrave copper layer for conventional gravure cylinders.

One or more pigments can be added to the curable composition in order to enhance its laser engravability. The pigment can be present in the laser engravable composition in an amount of from about 1 part by weight to about 25 parts by weight, in one embodiment from about 3 parts by weight to about 20 parts by weight. Examples of such pigments include, but are not limited to, black silicic pigments (containing carbon-encapsulated silica particles), and carbon black.

Optionally, the engraved layer can be further treated by polishing to remove burrs, and/or by applying a coating of a fluoropolymeric composition over the engraved layer (i.e., overcoat) to improve the ink releasability of the printing form.

After the layer is engraved, it is heated in a second curing step to complete the curing of the resin at a second temperature that is greater than the first temperature. In this second curing step, hardening of the resin composition occurs by reaction of the remaining epoxide functional groups of the epoxy resin, which can be promoted by the optional catalytic curing agent (i.e., by homopolymerization of the polymer chains with the remaining epoxide groups), the optional latent curing agent (i.e., reaction of the epoxide groups with the latent curing agent), and the optional reactive diluent. In some embodiments, the second temperature occurs in a range from greater than the first temperature to about 250° C. In some embodiments, the second temperature of the second curing step for the process described herein is between about 100° C. to about 250° C. The second temperature of the second curing step in some embodiments is between about 130° C. and about 220° C., and in other embodiments is between 120° C. and about 220° C. In yet other embodiments, the second temperature is in a range of about 100° C. to greater than about 180° C. The second temperature of the second curing step is far enough apart from the first temperature of the first curing step that the curing mechanism for the first curing step is essentially only the reaction of the amine curing agent with the epoxy resin. In most embodiments, there is at least about a 10° C. differential between the first temperature and the second temperature. In some embodiments, the temperature is in a range between and optionally including any two of the following values: 100, 110, 120, 130, 140 150, 160 170, 180, 190, 200, 210, 220, 230, 240, and 250° C. The layer is heated to the second temperature for a time sufficient for the second curing step so that the remaining epoxy functional groups are reacted or substantially reacted and that is reasonable for a commercially viable process. In general, the rate of curing for the second curing step will be rather slow in the low end of the temperature range. In some embodiments, the second curing step is complete in less than about 6 hours. In some embodiments, the second curing step is complete in less than 4 hours; in some other embodiments, the second curing step is complete in about 1 hour to about 2 hours. Times and temperatures will depend on the specific curable composition and the type and amount of the optional catalytic curing agent, and the type and amount of the optional latent curing agent, and are readily determined by one skilled in the art.

In some embodiments, the printing form is in the shape of a cylinder or plate. In some embodiments, the supporting substrate is metal or a polymer. In most embodiments, the printing form is suited for gravure printing. Gravure printing is a method of printing in which the printing form prints from an image area, where the image area is depressed and consists of small recessed cells (or wells) to contain the ink or printing material, and the non-image area is the surface of the form. In most embodiments, the printing surface is the cured layer of the epoxy composition that is engraved to form an ink receptive cell surface suitable for gravure printing. It is also contemplated that in some embodiments the printing form can be suited for relief printing, including use as a letterpress printing form. Relief printing is a method of printing in which the printing form prints from an image area, where the image area of the printing form is raised and the non-image area is depressed. For printing forms useful for relief printing, the engraving of at least one cell creates the non-image area that would not carry ink for printing the desired image, and the surface raised above the cell is the image area that carries ink for printing the desired image. In some embodiments the printing surface is a relief surface suitable for relief printing.

In a further embodiment, a printing form is provided that includes a continuous polymer-based gravure print surface adjacent to a supporting substrate, wherein the continuous print surface is a cured epoxy composition prepared from a curable composition comprising i) an epoxy resin having epoxide functionalities; and ii) a less than stoichiometric amount of at least one amine curing agent; by applying the curable composition onto a supporting substrate, thereby forming a layer; partially curing the layer at a first temperature sufficient to cause the at least one amine curing agent to react with the epoxide functionalities of the epoxy resin, wherein the layer after the first curing step includes unreacted epoxide functionalities; engraving at least one cell in the resulting partially cured layer; and further curing the engraved layer at a second temperature greater than the first temperature, thereby forming the continuous print surface of the printing form.

In another embodiment, a process is provided for printing with the printing form that was prepared as described above. In some embodiments, the process for printing further includes applying an ink, typically a solvent ink, to the at least one cell that has been engraved into the cured layer of the prepared printing form, and transferring ink from the cell to a printable substrate. In other embodiments, the process for printing further includes applying an ink to at least a surface above the cell that has been engraved into the cured layer of the prepared printing form, and transferring ink from the raised surface to a printable substrate. Suitable solvent inks include those based on organic solvents such as, without limitation, alcohols, hydrocarbons (e.g., toluene, heptane), acetates (e.g., ethyl acetate), and ketones (e.g., methyl ethyl ketone).

When the cured layer is not adequately solvent resistant, absorbing solvent from the solvent ink can cause the cured layer to swell excessively. Swelling excessively is detrimental to print quality and to the durability of the image carrier. The amount of swelling in terms of cured layer weight gain in the process described herein is less than about 10 parts by weight. In some embodiments, the amount of swelling of the cured layer is between 0 and about 5 parts by weight. This can be achieved in part through the choice of the amine and catalytic curing agents. In addition, the structure of epoxy resin affects the amount of swell. For example, increased crosslinking of the polymer chains in the epoxy resin can lead to reduced swell, i.e., improved solvent resistance, of the cured layer.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations is as follows: “AHEW” means amine hydrogen equivalent weight; “cm” means centimeter(s); “cp” means centipoise(s); “EEW” means epoxide equivalent weight; “EPHS” means epoxidized polyhydroxystyrene “EMI” means 2-ethyl-4-methylimidazole; “equiv” means equivalent(s); “g” means gram(s); “h” means hour(s); “MEK” means methyl ethyl ketone; “millitorr” means 0.001 mm of mercury, a pressure equal to 0.13332237 pascal; “mg” means milligrams; “mL” means milliliters; “mm” means millimeter(s); “mil” means 0.001 inch, a length equal to 0.0254 millimeters; “min” means minute(s); “N” means newton(s); “¹H NMR” means proton nuclear magnetic resonance spectroscopy; “TETA” means triethylene tetramine; “wt %” means weight percent(age); and “μm” means micrometer(s).

### Methods

### Solvent Resistance

Epoxy resin compositions were prepared and coated on an aluminum foil sheet support using a drawdown bar with a 15 to 20 mil (381-508 μm) gap to form a polymeric film (i.e., layer) on the support. The polymeric film samples were cured according to specifications in the Example, and peeled from the support. Film fragments (typically 50-100 mg) were weighed into jars containing 10-20 mL of specified solvent. The film fragments were immersed for one week (i.e., 7 days), then blotted dry and weighed. The wt % change is calculated as:

100*[weight(7 day)−weight(initial)]/weight(initial).

The composition was deemed to have good solvent resistance if, after 7 days in the solvent, the wt % change of the fragments was less than 12%.

### Hardness

Epoxy resin compositions were prepared and coated on a steel sheet support using a drawdown bar with a 15 to 20 mil (381-508 μm) gap to form a polymeric film (i.e., layer) on the support. The polymeric film samples were cured according to specifications in the Example. A Fischerscope® HM2000 instrument, with WIN-HCU® software, manufactured by Helmut Fischer GMbH, was used to measure the Martens Hardness of the cured coating according to test method ISO 14577.

### Engravability

Epoxy resin compositions were prepared, coated onto a cylinder, cured and engraved as indicated in the Example. A cured resin sample was deemed to have good engravability if engraving of the sample to create cells at 170 to 200 lines per inch could be achieved with less than 15% breakout. Engraved image resolution of 170 to 200 lines per inch corresponds to a cell width of about 115 to 140 μm and a width of a cell wall of less than 25 μm. A breakout is defined herein as a defect in which a wall adjacent to two cells has a break in it, thereby producing a connection between the two cells. The engraved area was examined microscopically, and at least about 30-50 cells were examined to determine the breakout percentage.

### Wear

An in-house wear test was established to mimic a typical gravure printing process. For the wear test, the (engraved) cylinder, which has a cured layer of the composition, was rotated, partially immersed in the ink tray, and was contacting a steel doctor blade once per revolution. The ink used for the test was Multiprint White ink from Del Val Ink and Color Inc. The cell area of the engraved cylinder was measured before and after 300,000 revolutions to monitor the extent of wear with a Hirox KH-7700 microscope. Wear is reported as a percent reduction in cell area. The cured layer was considered to have acceptable wear resistance if the reduction in cell area induced by the in-house tester was less than 10%.

### Softening Point

Manufacturers' reported softening points measured according to ASTM D-3104 were used when available. Otherwise, it was inferred that a material described as “liquid” at some temperature has a softening point lower than that temperature.

### Materials

Epoxidized polyhydroxystyrene, referred to herein as EPHS, was synthesized from PB5 branched polyhydroxystyrene obtained from Hydrite Chemical, Cottage Grove, Wis. A mixture of 93 g (0.02 mol) PB5, 372 g (4.04 mol) epichlorohydrin, 217.2 g (0.785 mol) isopropyl alcohol and 49.2 g water was placed into a 2-liter 3-neck round bottom flask. The flask was equipped with over-head mechanical stirrer, a condenser with nitrogen blanket, thermometer and water bath to warm the reaction mixture to 80° C. Then 192.8 g of 20% NaOH/H₂O was added to the solution drop-wise over ˜40 minutes. After reaction, excess epichlorohydrin and solvents were removed by vacuum distillation or rotovapping. The salts were removed from the resin by dissolving the product mixture in acetone and filtering. Acetone was removed from the filtrate by vacuum distillation or rotovapping. The product was characterized by ¹H NMR in acetone-d6 and epoxy equivalent weight by ASTM D1652-04, Test Method B. The NMR spectrum confirmed essentially complete epoxidation. The EPHS obtained had an epoxy equivalent weight of 233.

D.E.N.™ 431 epoxy novolac resin was obtained from The Dow Chemical Company (Midland, Mich., U.S.A.). Properties of this resin are EEW of 172-179 g/equiv, viscosity of 1100-1700 mPa·s at 51.7° C., and multi-epoxy functionality (±2.8).

EPON™ Resin 828 (diglycidyl ether of Bisphenol A, “DGEBPA”) was obtained from Hexion Specialty Chemicals, Inc. (now Momentive Specialty Chemicals, Inc., part of Momentive Performance Materials Holdings, Inc., Columbus, Ohio, U.S.A.). Properties of this resin are EEW of 185-192 g/equiv, viscosity of 110-150 P.

Araldite® DY-P (monoglycidylether of p-tert-butylphenol, CAS #3101-60-8), referred to herein as DY-P, was obtained from Huntsman Advanced Materials (The Woodlands, Tex., U.S.A.). EEW is 222-244 g/equiv. Its softening point is below 25° C. and its viscosity at 25° C. is 20-28 cp.

Araldite® DY-D (diglycidylether of 1,4-butanediol, CAS #2425-79-8), referred to herein as DY-D, was obtained from Huntsman Advanced Materials. EEW is 118-125 g/equiv. Its softening point is below 25° C. and its viscosity at 25° C. is 15-20 cp.

Araldite® GY-285 (diglycidylether of bisphenol F, CAS #2095-03-6), referred to herein as GY-285, was obtained from Huntsman Advanced Materials. EEW is 163-172 g/equiv. Its softening point is below 25° C. and viscosity at 25° C. is 2000-3000 cp.

Nanodur® X1130PMA aluminum oxide (CAS #1344-28-1), referred to herein as alumina, was obtained from Alfa Aesar (Ward Hill, Mass., USA). It is a 50% colloidal dispersion of 45 nm APC aluminum oxide in 1,2-propanediol monomethyl ether acetate.

Triethylene tetraamine (CAS #112-24-3), referred to herein as TETA, was obtained from MP Biomedicals LLC (Solon, Ohio, U.S.A.). AHEW is approximately 27.

2-Ethyl-4-methylimidazole (CAS #931-36-2), referred to herein as EMI, was obtained from Sigma-Aldrich Co. LLC and warmed if necessary to liquify it before using.

Methyl ethyl ketone (CAS #78-93-3), referred to herein as MEK, was obtained from Sigma-Aldrich Co. LLC.

Propylene glycol monomethyl ether acetate was obtained from Aldrich.

N-butanol was obtained from Aldrich.

Toluene (CAS #108-88-3) and ethyl acetate (CAS #141-78-6) were obtained from EMD Chemicals, Inc. (Gibbstown, N.J., U.S.A.).

### Examples 1-3

This example demonstrates that an epoxy formulation coated on a gravure printing cylinder, partially cured, engraved, and then fully cured, exhibits good performance as a printing form for gravure, including coatability, engravability, wear resistance, and solvent resistance.

Table 1 shows the amounts of each formulation ingredient in each example. For each of the three examples, the indicated amount of EPHS epoxidized polyhydroxystyrene was placed in a round bottom flask. Approximately 25 g MEK was added to each flask, and the EPHS solid was dissolved with stirring. The remaining epoxy components, Araldite® GY-285 bisphenol F epoxy, Araldite® DY-P epoxy diluent (monoglycidylether of p-tert-butylphenol), and Araldite® DY-D epoxy diluent (diglycidylether of 1,4-butanediol), were added to each flask. For example 3, alumina was also added to the flask, and additional MEK was also added to achieve complete dissolution upon heating. Each flask was heated with stirring at 45-50° C. until the mixture was completely fluid and uniform.

To remove solvent from each formulation, a short path distillation apparatus was set up with a receiving flask chilled by dry ice, a trap, and vacuum supplied by a pump. The flasks containing each of the three formulations were, in turn, placed in the distillation apparatus and the contents maintained at 45-50° C. until no more solvent was coming over to the receiving flask.

Just prior to coating a cylinder, each sample was warmed to 30-35° C. and the amounts of TETA and EMI indicated in Table 1 were added to the sample with stirring. Each sample was degassed under vacuum (200-1000 millitorr) for approximately 10 minutes while maintaining the heat and stirring.

TABLE 1

| Exam- | EPHS | GY-285 | DY-P | DY-D | Alumina | TETA | EMI |
|---|---|---|---|---|---|---|---|
| ple | (g) | (g) | (g) | (g) | (g) | (g) | (g) |
| 1 | 10.51 | 12.24 | 9.21 | 3.08 | | 2.24 | 1.10 |
| 2 | 10.50 | 12.31 | 9.20 | 3.07 | | 3.29 | 1.08 |
| 3 | 9.00 | 10.60 | 7.89 | 2.73 | 12.45 | 2.84 | 0.91 |

The sample was introduced into a metal syringe. It was then coated onto a metal cylinder that had been preheated to 45-50° C. The cylinder was coated using a brush technique with a combined syringe pump and translator mechanism to deliver material to obtain the desired coating thickness (6-10 mils, 152-254 μm). Each of the three coatings was applied by the same procedure to approximately ⅓ of the length of the cylinder. The coatings were then cured at 80° C. for 1 h and allowed to cool to ambient temperature gradually. All three compositions coated well and cured to form an excellent partially cured layer on the cylinder.

The partially cured coatings on the cylinder were ground and polished mechanically without difficulty to a uniform thickness of 4.6 to 4.8 mils (117 to 122 μm) and then engraved on an Ohio R-7100 series engraver at cell rate 3200 Hz, with vertical screen setting 274 cells/Rev, Horizontal screen setting 80 cells/length & single repeat setting 800 ¼ cells. The screen was 80 lines/cm, angle 60 deg, tone 100% & diamond face angle 120 deg. Engraving quality was good, with 3%, 9%, and 2% broken cell walls at 100% cell density for the coatings of examples 1, 2, and 3, respectively.

Following engraving, the cylinder was placed in an oven and heated at 150° C. for 2 hours to complete curing. The appearance of engraved cells was unchanged by this additional curing. A wear test was performed on these fully cured cylinder coatings according to the method described above. The reduction in cell area induced by the in-house tester was 7, 6 and 9% for the coatings of examples 1, 2, and 3, respectively, indicative of good wear resistance.

Portions of the above coating formulations not used for cylinder coating were used to prepare films for solvent resistance testing, according to the method described above. Solvent resistance in MEK was determined on films partially cured at 80° C. for 1 h as well as in MEK, ethyl acetate, and toluene on films that were both partially cured at 80° C. for 1 h and then fully cured at 150° C. for 2 h, the same curing conditions used for the cylinder coating. The results are in Table 2.

TABLE 2

7 Day Solvent Uptake (wt %)

| | |
|---|---|
| After partial | |
| cure | After partial and full cure |

Solvent

| | MEK | MEK | Ethyl acetate | toluene |
|---|---|---|---|---|
| Ex. 1 | 44.3 | 2.5 | 1.2 | 1.3 |
| Ex. 2 | 28.3 | 2.0 | 0.1 | 1.5 |
| Ex. 3 | 36.9 | 17.5 | 14.5 | 6.0 |

The significant MEK uptake upon partial cure is consistent with a low level of crosslinking. Upon full cure, the MEK uptake was dramatically reduced. The solvent resistance of the fully cured Ex. 1 and Ex. 2 coatings was excellent for all three solvents. Ex. 3 showed somewhat high solvent uptake, but it is believed that this behavior was due to voids caused by poor dispersion of the alumina in the coating, not insufficient crosslinking.

Portions of the above coating formulations not used for cylinder coating were used to prepare coatings for hardness testing, according to the method described above. Hardness was determined on coatings partially cured at 80° C. for 1 h as well as on coatings that were both partially cured at 80° C. for 1 h and then fully cured at 150° C. for 2 h, the same curing conditions used for the cylinder coating. The results are in Table 3.

TABLE 3

Fischerscope Hardness (N/mm²)

| | After partial cure | After partial and full cure |
|---|---|---|
| Ex. 1 | 69.8 | 185.1 |
| Ex. 2 | 170.1 | 178.5 |
| Ex. 3 | 153.1 | 180.7 |

Fischerscope hardness increases upon full cure for each coating, and especially for Ex. 1. The softer partially cured coating engraves well, while the harder fully cured coating is expected to have better durability.

Based upon the results for the engravability, wear resistance, solvent resistance, and hardness, it is expected that the curable compositions of these examples should produce excellent quality prints and have a long print run life.

### Example 4

This example demonstrates that a bisphenol A epoxy formulation coated on a steel plate, partially cured, engraved, and then fully cured, showed better engravability after partial cure. After full cure, the solvent resistance improved.

EPON™ resin 828 (bisphenol A epoxy) was dissolved in the solvent mixture A as a 84 wt % stock solution. Solvent A contained xylene: MEK: n-butanol:butyl acetate:propylene glycol monomethyl ether acetate in a 40:28:22:7:3 weight ratio. The epoxy solution (15 g 84 wt % solution, or 12.6 g solids) was transferred to a round bottom flask and to this was added 0.89 g of TETA followed by 0.51 g of EMI (dissolved in solvent A as a 50 wt % mixture). The material was stirred at room temperature for 5 minutes, then coated on a steel plate with a doctor blade to 10 mil thickness. The plate was heated to 85° C. for 45 minutes, then cooled to room temperature. The plate was then engraved by a diamond stylus. The engraved cells of the partially cured film had smooth edges. The plate was then heated to 160° C. for 2 hours. The same plate, now fully cured, was engraved by a diamond stylus. The engraved cells had more jagged edges and were irregular in shape, indicating poor engraving.

Portions of the above coating formulations not used for flat plate coating were used to prepare films for solvent resistance testing, according to the method described above. Solvent resistance was determined on film partially cured at 85° C. for 45 min as well on film that was both partially cured at 85° C. for 45 and then fully cured at 160° C. for 2 h, the same curing conditions used for the cylinder coating. The results are in Table 4.

TABLE 4

| | 7 Day Solvent Uptake (wt %) | | | | | |
|---|---|---|---|---|---|---|
| | After partial cure | | | After partial and full cure | | |
| | Solvent | | | | | |
| | | Ethyl | | | Ethyl | |
| | MEK | acetate | toluene | MEK | acetate | toluene |
| Ex. 4 | 19 | 13 | 2 | 0 | 1.3 | 1.2 |

The significant solvent uptake upon partial cure is consistent with a low level of crosslinking. Upon full cure, the solvent uptake is dramatically reduced. Based upon the results for the flat plate engravability and solvent resistance, it is expected that the curable composition of the epoxy composition should produce excellent quality prints and have a long print run life.

### Example 5

This example demonstrates that an epoxy novolac formulation coated on a steel plate, partially cured, engraved, and then fully cured, showed better engravability after partial cure than after full cure.

D.E.N.™ 431 was dissolved in the solvent mixture B as a 80% stock solution. Solvent B was xylene: MEK: n-butanol:butyl acetate:butyl acetate in a 41:29:22:8 weight ratio. The epoxy solution (10 g 80% solution, 8 g solids) was transferred to a round bottom flask and to this was added 0.56 g of TETA followed by 0.2 g of EMI (dissolved in solvent B as a 50 wt % mixture). The material was stirred at room temperature for 5 minutes, and then coated on a steel plate with blade coating to 10 mil thickness. The plate was heated to 100° C. for 30 minutes, then cooled to room temperature. The plate was then engraved by a diamond stylus. The engraved cells of the partially cured film had smooth edges. The plate was then heated to 160° C. for 1 hour. The same plate, now fully cured, was engraved by a diamond stylus. The engraved cells had more jagged edges and are irregular in shape, indicating poor engraving.

Portions of the above coating formulations not used for flat plate coating were used to prepare films for solvent resistance testing, according to the method described above. Solvent resistance was determined on film partially cured at 100° C. for 30 min as well on film that was both partially cured at 100° C. for 30 min and then fully cured at 160° C. for 1 h, the same curing conditions used for the cylinder coating. The results were 3 wt % MEK uptake after 7 days for the partially cured sample and 1.5 wt % for the fully cured sample.

Based upon the results for the flat plate engravability and solvent resistance, it is expected that the curable composition of the epoxy novolac composition should produce excellent quality prints and have a long print run life.

### Example 6

This example demonstrates that an epoxy novolac formulation containing a substoichiometric amount of ambient amine curing agent and a latent amine curing agent, coated on a steel plate, partially cured, engraved, and then fully cured, showed better engravability after partial cure than after full cure.

D.E.N.™ 431 was dissolved in the 75% MEK/25% Dowanol®PM as a 80% stock solution. The epoxy solution (10 g 80% solution, 8 g solids) was transferred to a round bottom flask and to this was added 1.42 g of 4,4′-diaminodiphenyl sulfone, followed by 0.56 g of TETA. The material was stirred at room temperature for 5 minutes, and then coated on a steel plate with blade coating to 10 mil thickness. The plate was heated to 100° C. for 30 minutes, then cooled to room temperature. The plate was then engraved by a diamond stylus. The engraved cells of the partially cured film had smooth edges. Another plate was coated with the same formulation, but cured to 100° C. for 30 min, then heated to 160° C. for 1 hour. This epoxy coated plate, cured in two stages, was engraved by a diamond stylus. The engraved cells had more jagged edges and are irregular in shape, indicating poor engraving.

Portions of the above coating formulations not used for flat plate coating were used to prepare films for solvent resistance testing, according to the method described above. Solvent resistance was determined on film partially cured at 100° C. for 30 min as well on film that was both partially cured at 100° C. for 30 min and then fully cured at 160° C. for 1 h, the same curing conditions used for the cylinder coating. The results were −0.5 wt % MEK uptake after 7 days for the partially cured sample and 0.5 wt % for the fully cured sample.

Based upon the results for the flat plate engravability and solvent resistance, it is expected that the curable composition of the epoxy novolac composition should produce excellent quality prints and have a long print run life.

### Comparative Examples A-C

To compare engravability of a fully vs. partially cured coating, the cylinder coatings of Examples 1, 2, and 3 were re-engraved in a different area after the two-stage partial and full curing was complete. Upon inspection of the engraved cells, it was found that there were 12%, 33%, and 7% broken cell walls at 100% cell density for the coatings of Comparative Examples A, B, and C, respectively. These breakout percentages are all significantly worse than those for the corresponding partially cured coatings of Examples 1, 2, and 3, which exhibited 3%, 9%, and 2% broken cell walls, respectively.

What is claimed is:

1. A process for preparing a printing form comprising:
a) applying a curable composition comprising:
i) an epoxy resin having epoxide functionalities, and
ii) a less than a stoichiometric amount of at least one amine curing agent onto a supporting substrate, thereby forming a layer;
b) in a first curing step, curing the layer at a first temperature sufficient to cause the at least one amine curing agent to react with the epoxide functionalities of the epoxy resin, wherein the layer after the first curing step includes unreacted epoxide functionalities;
c) engraving at least one cell in the layer resulting from step b); and
d) in a second curing step, further curing the engraved layer at a second temperature greater than the first temperature sufficient to cause the unreacted epoxide functionalities to react, thereby forming the printing form.

2. The process of claim 1 wherein the curable composition comprises more than one amine curing agent.

3. The process of claim 1 wherein the curable composition further comprises: iii) a catalytic curing agent; and/or
iv) a latent curing agent.

4. The process of claim 1 wherein the first temperature is in a range of room temperature to 150° C.

5. The process of claim 1 wherein the second temperature is in a range from greater than the first temperature to about 250° C.

6. The process of claim 1 wherein the applying step comprises coating the curable composition as a liquid having a viscosity of 200 to 5000 cP.

7. The process of claim 1 wherein the curable composition comprises an aliphatic amine as the at least one amine curing agent and further comprises an imidazole as a catalytic curing agent, the first curing step occurs at the first temperature in the range of room temperature to 120° C., and the second curing step occurs at the second temperature in the range of 125° C. to 250° C.

8. The process of claim 1 wherein the epoxy resin is epoxy novolac resin, bisphenol A-based resin, bisphenol F-based resin, epoxidized polyhydroxystyrene resin, or a combination comprising any of these.

9. The process of claim 1 wherein the at least one amine curing agent has amine hydrogens, and a ratio of the amine hydrogens of the amine curing agent to the epoxy functionalities of the epoxy resin in the curable composition is between about 0.30:1.0 to about 0.90:1.0, on a mole-to-mole basis.

10. The process of claim 1 wherein the amine curing agent is selected from the group consisting of: triethylenetetramine, diethylenetriamine, tetraethylenepentamine; 1,2-diaminocyclohexane; 1,3-bis(aminomethyl)cyclohexane; m-phenylenediamine; m-xylylene diamine; and mixtures of these.

11. The process of claim 1 wherein the catalytic curing agent is selected from the group consisting of: 2-methylimidazole, 2-ethyl-4-methylimidazole, boron trifluoride-monomethylamine, boron trifluoride-monoethylamine, boron trifluoride-dimethyl ether, boron trifluoride-diethyl ether, and boron trifluoride-tetrahydrofuran, and boron trichloride-trimethylamine.

12. The process of claim 1 wherein the curable composition further comprises an epoxy reactive diluent or mixture of diluents.

13. The process of claim 12 wherein the epoxy reactive diluent or mixture of diluents is selected from the group consisting of: p-tertiarybutyl phenyl glycidyl ether, cresyl glycidyl ether, benzyl glycidyl ether, 2-ethylhexyl glycidyl ether, and C8-C14 glycidyl ether, 1,4-butanediol diglycidyl ether, neopentyl glycol diglycidyl ether, cyclohexane dimethanol diglycidyl ether, and trimethylol propane triglycidyl ether, and mixtures thereof.

14. The process of claim 1 wherein the composition further comprises an accelerator.

15. The process of claim 14 wherein the accelerator is a tertiary amine or phenol.

16. The process of claim 14 wherein the accelerator is selected from the group consisting of: 2,4,6-tris(dimethylaminomethyl)phenol, dimethylaminomethyl phenol, dimethylaminoethanol, benzyldimethylamine, 1,8-diazabicyclo[5.4.0]undec-7-ene, phenol, resorcinol, nonylphenol, and poly(4-vinyl phenol).

17. The process of claim 1 wherein the composition further comprises up to 30 parts by weight nanoparticles having at least one dimension less than 500 nm.

18. The process of claim 17 wherein the nanoparticles have at least one dimension less than 100 nm.

19. The process of claim 17 wherein the nanoparticles comprise at least one member of the group consisting of: aluminum oxides, colloidal silica, fumed silica, zinc oxide, zirconium oxide, titanium oxide, tungsten oxides, magnesium oxides, tungsten carbides, silicon carbide, titanium carbide, boron nitrides, molybdenum disulfide, clay, carbon nanotubes, carbon black, carbon filaments, and mixtures thereof.

20. The process of claim 19 wherein the clay is at least one member of the group consisting of: laponite, bentonite, montmorillonite, hectorite, kaolinite, dickite, nacrite, halloysite, saponite, nontronite, beidellite, volhonskoite, sauconite, magadite, medmonite, kenyaite, vermiculite, serpentines, attapulgite, kulkeite, alletite, sepiolite, allophane, imogolite, and mixtures thereof.

21. The process of claim 1 wherein the engraving step is selected from electromechanical engraving or laser engraving.

22. The process of claim 1 wherein the supporting substrate is in the form of a cylinder or sheet.

23. A process for gravure printing with a printing form comprising:
a) preparing the printing form having a cured engraved layer according to the process of claim 1;
b) applying an ink to the at least one cell; and
c) transferring ink from the cell to a printable substrate,
wherein the cured layer swells ≦12% based on weight of the layer.

24. A printing form comprising a continuous print surface adjacent to a supporting substrate, wherein the continuous print surface is a cured epoxy composition prepared by:
a) applying onto a supporting substrate a curable composition comprising:
i) an epoxy resin having epoxide functionalities,
ii) a less than a stoichiometric amount of at least one amine curing agent, thereby forming a layer;
b) in a first curing step, curing the layer at a temperature in a range of room temperature to about a first temperature sufficient to cause the at least one amine curing agent to react with the epoxide functionalities of the epoxy resin, wherein the layer after the first curing step includes unreacted epoxide functionalities;
c) engraving at least one cell in the layer resulting from step b); and,
d) in a second curing step, further curing the engraved layer at a second temperature greater than the first temperature sufficient to cause the unreacted epoxide functionalities to react, thereby forming the printing form.

25. The printing form of claim 24 wherein the curable composition further comprises up to 30 parts by weight nanoparticles.

26. The printing form of claim 24 wherein the curable composition further comprises iii) a catalytic curing agent; and/or iv) a latent curing agent.

27. The printing form of claim 24 wherein the printing form is in the shape of a cylinder or plate.

28. The printing form of claim 24 wherein the substrate is metal or a polymer.

29. A process for preparing a printing form comprising:
a) providing a curable composition comprising:
i) an epoxy resin having epoxide functionalities,
ii) a less than a stoichiometric amount of at least one amine curing agent;
b) applying the composition onto a supporting substrate, thereby forming a layer;
c) in a first curing step, curing the layer at a first temperature sufficient to cause the at least one amine curing agent to react with the epoxide functionalities of the epoxy resin, wherein the layer after first curing step includes unreacted epoxide functionalities;
d) engraving at least one cell in the layer resulting from step c); and
e) in a second curing step, further curing the engraved layer by heating at a second temperature greater than the first temperature to cause the unreacted epoxide functionalities to react.

30. The process of claim 29 wherein the first temperature is in a range of room temperature to 150° C., and the second temperature is in a range from greater than the first temperature to about 250° C.

31. A polymer-based gravure printing form produced by the process of claim 1.

32. The process of claim 1 further comprising prior to engraving step (c), polishing the layer resulting from step (b).

33. The process of claim 1 further comprising prior to engraving step (c), grinding the layer resulting from step (b).
